(19) United States
(12) Patent Application Publication
(10) Pub. No.: US 2019/0042678 A1
(43) Pub. Date: Feb. 7, 2019

(54) PREDICTION APPARATUS AND PREDICTION METHOD

(71) Applicant: FUJITSU LIMITED, Kawasaki-shi (JP)

(72) Inventors: Hitoshi Komoriya, Machida (JP); Tetsuyoshi Shiota, Yokohama (JP); Katsuhito Nakazawa, Urawa (JP)

(73) Assignee: FUJITSU LIMITED, Kawasaki-shi, Kanagawa (JP)

(21) Appl. No.: 16/044,064

(22) Filed: Jul. 24, 2018

(30) Foreign Application Priority Data
Aug. 4, 2017 (JP) 2017-151941

(51) Int. Cl. G06F 17/50

(52) U.S. Cl. CPC G06F 17/5009; G06F 2217/16

(57) ABSTRACT

A prediction apparatus includes one or more memories and one or more processors configured to select each of specific periods for each of a plurality of explanatory variables on the basis of a correlation between actual values of each of the plurality of explanatory variables aggregated for each period and actual values of an objective variable aggregated for each period, the plurality of explanatory variables relating to the objective variable, determine a plurality of regression coefficients of a regression equation relating to the objective variable on the basis of each specific actual value of the plurality of explanatory variables in each of the selected specific periods, perform calculation of a predicted value of the objective variable by using the regression equation having the determined plurality of regression coefficients, and output the calculated predicted value.

### CROSS-REFERENCE TO RELATED APPLICATION

This application is based upon and claims the benefit of priority of the prior Japanese Patent Application No. 2017-151941, filed on Aug. 4, 2017, the entire contents of which are incorporated herein by reference.

### FIELD

The embodiments discussed herein are related to a prediction technique.

### BACKGROUND

Local governments such as cities, towns, and villages have been demanded to plan effective policies for various social problems (for example, population decrease, declining birthrate, population aging, and the like). In planning policies, it is desired to quantitatively verify the effect of introducing policies without depending on empirical rules, and future prediction by simulation is being studied.

It is an effective prediction method to calculate a calculation model by regression analysis of time-series data of an objective variable (variable to be predicted) and an explanatory variable (a variable related to objective variable) in future prediction by simulation.

For example, related technologies are disclosed in Japanese Laid-open Patent Publications Nos. 2017-10173 and 2003-242305.

### SUMMARY

According to an aspect of the invention, a prediction apparatus includes one or more memories and one or more processors configured to select each of specific periods for each of a plurality of explanatory variables on the basis of a correlation between actual values of each of the plurality of explanatory variables aggregated for each period and actual values of an objective variable aggregated for each period, the plurality of explanatory variables relating to the objective variable, determine a plurality of regression coefficients of a regression equation relating to the objective variable on the basis of each specific actual value of the plurality of explanatory variables in each of the selected specific periods, perform calculation of a predicted value of the objective variable by using the regression equation having the determined plurality of regression coefficients, and output the calculated predicted value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of a prediction system;

FIG. 2 is a diagram illustrating an example of time-series data of a local government among time-series data stored in a time-series data storage device;

FIG. 3 is a diagram illustrating an example of time-series data nationwide among time-series data stored in the time-series data storage device;

FIG. 4 is a diagram illustrating an example of a hardware configuration of a server device;

FIG. 5 is a diagram illustrating an example of a functional configuration of the server device;

FIG. 6 is a diagram illustrating a specific example of an operation screen transmitted by a simulation request reception unit;

FIG. 7 is a diagram illustrating a specific example of processing by a correlation coefficient calculation unit;

FIG. 8 is a diagram illustrating a specific example of processing by a model calculation unit;

FIG. 9 is a diagram illustrating a specific example of processing by a regression analysis unit;

FIG. 10 is a first diagram illustrating a specific example of processing by a predicted value calculation unit;

FIG. 11 is a second diagram illustrating a specific example of processing by the predicted value calculation unit;

FIG. 12 is a diagram illustrating a specific example of processing by a simulation result output unit;

FIG. 13 is a flowchart illustrating a flow of prediction processing; and

FIG. 14 is a diagram for verifying a simulation result.

### DESCRIPTION OF EMBODIMENTS

In the related art, an objective variable of the year to be predicted is calculated by weighting and adding the objective variable of the year before the year to be predicted and a plurality of explanatory variables of the year before the year to be predicted. On the other hand, when focusing on the correlation between the objective variable and each explanatory variable, a correlation value between the objective variable of the year to be predicted and the explanatory variable of the year to be predicted is not necessarily the maximum. For example, it is also conceivable that explanatory variables before the previous year may greatly influence the objective variable of the year to be predicted.

In other words, in the related calculation model, there was a case where an objective variable of the year to be predicted is calculated by using the explanatory variable of the year with the maximum correlation value, and prediction accuracy may not be realized sufficiently in a future prediction by simulation.

Hereinafter, each embodiment will be described with reference to the attached drawings. In the present specification and the drawings, the same reference numerals are given to constituent elements having substantially the same functional configuration, and redundant description will be omitted.

### First Embodiment

System Configuration of Prediction System

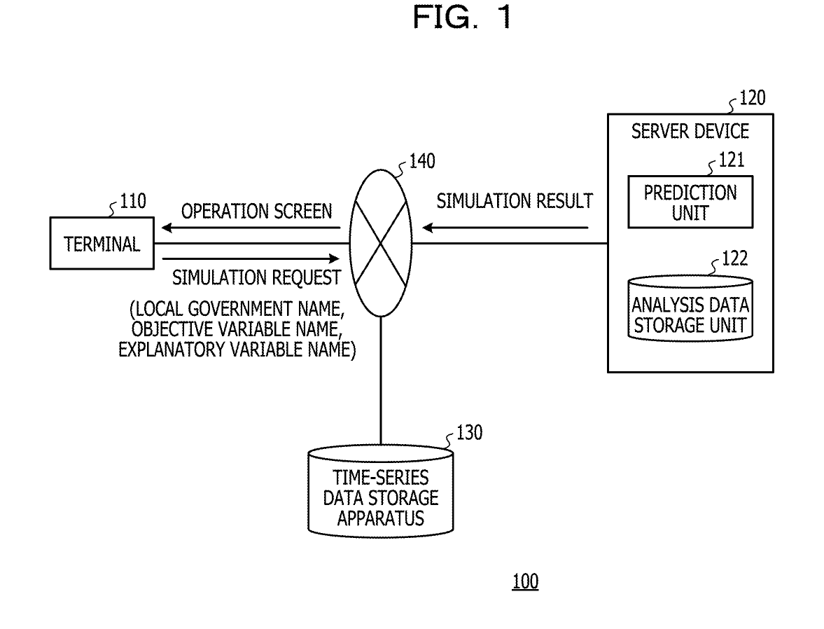

First, the system configuration of the prediction system will be described. FIG. 1 is a diagram illustrating an example of a system configuration of a prediction system.

As illustrated in FIG. 1, a prediction system 100 includes a terminal 110, a server device 120, and a time-series data storage device 130. The devices included in the prediction system 100 are mutually connected via a network 140.

For example, the terminal 110 is installed in a local government and used by a user who performs a policy-making business. A Web browser is installed in the terminal 110, and when the Web browser accesses the server device 120 via the network 140, the terminal 110 requests an operation screen for making a simulation request to the server device 120.

In addition, the terminal 110 receives and displays an operation screen from the server device 120 via the Web browser. The user inputs the name of the local government to be predicted on the displayed operation screen and selects an objective variable name (variable name to be predicted (for example, “population”)), an explanatory variable name (variable name of the explanatory variable strongly related to the actual value of the objective variable (for example, “number of births”)).

The terminal 110 transmits a simulation request including the local government name, the objective variable name, and the explanatory variable name input or selected by the user to the server device 120 and requests future prediction by simulation (calculation of a predicted value of an objective variable).

Further, the terminal 110 receives the simulation result transmitted from the server device 120 in response to the simulation request via the Web browser and displays the simulation result on the operation screen.

The server device 120 is an example of a prediction apparatus. A prediction program is installed in the server device 120, and the server device 120 functions as a prediction unit 121 by executing the prediction program.

The prediction unit 121 provides a prediction service by executing prediction processing. Specifically, the prediction unit 121 transmits an operation screen to the terminal 110 in response to an access from the terminal 110. In addition, the prediction unit 121 calculates a predicted value of the objective variable in response to the simulation request from the terminal 110 and transmits the simulation result to the terminal 110.

When calculating the predicted value of the objective variable, the prediction unit 121 calculates regression analysis data (details will be described later) in advance and stores the data in an analysis data storage unit 122.

The time-series data storage device 130 stores various time-series data (referred to as “local government time-series data”) managed by each local government. In addition, the time-series data storage device 130 stores various time-series data (referred to as “nationwide time-series data”) obtained by aggregating various time-series data managed by each local government (for example, approximately 1700 cities, towns, and villages nationwide) on a nationwide scale.

Details of Time-Series Data

(1) Details of Time-Series Data of Local Government

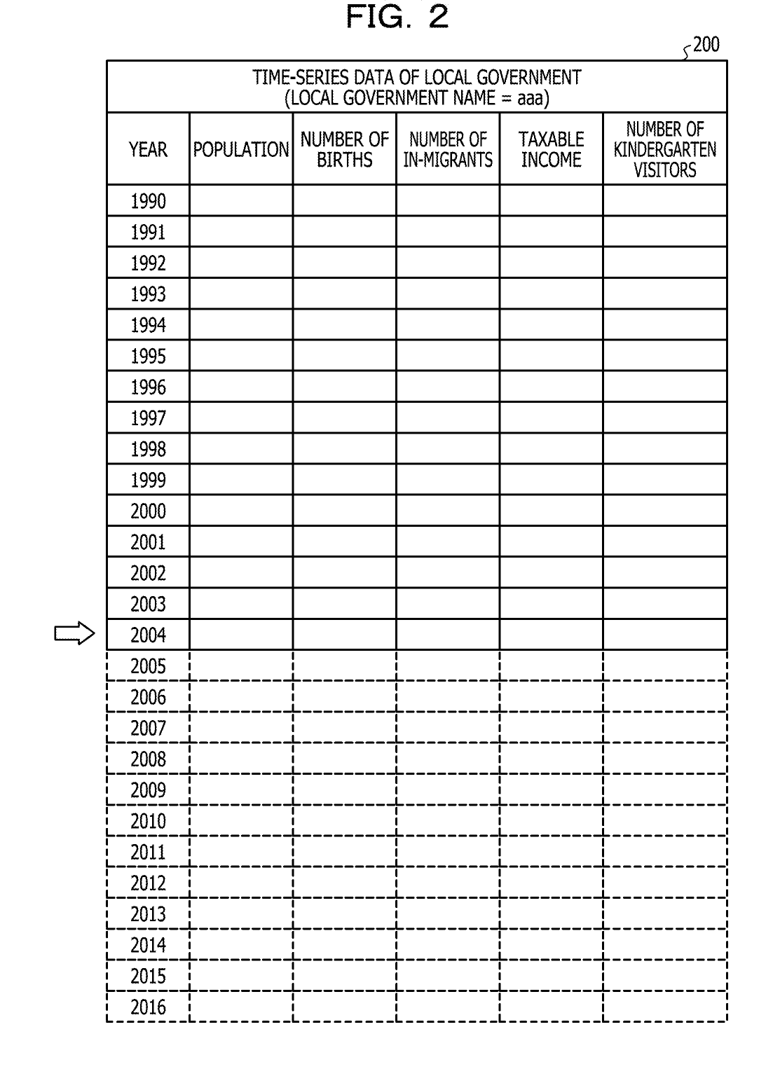

FIG. 2 is a diagram illustrating an example of time-series data of a local government among time-series data stored in a time-series data storage device. The example in FIG. 2 indicates that time-series data 200 of the local government with the local government name=“aaa”.

As illustrated in FIG. 2, the time-series data 200 of the local government includes, for example, “year”, “population”, “number of births”, “number of in-migrants”, “taxable income”, “number of kindergarten visitors”, and the like. In the “year”, a predetermined period (here, “year”) in which each actual value is aggregated in the local government with the local government name=“aaa” is recorded. In the first embodiment, it is assumed that the time-series data 200 of the local government is aggregated on a yearly basis.

In the “population”, the actual value of the population in each year aggregated in the local government with the local government name=“aaa” is recorded. In the “number of births”, the actual value of the number of births in each year aggregated in the local government with the local government=“aaa” is recorded.

In the “number of in-migrants”, the actual value of the number of in-migrants in each year aggregated in the local government with the local government name=“aaa” is recorded. In the “taxable income”, the actual values of taxable income in each year aggregated in the local government with the local government name=“aaa” are recorded. In the “number of kindergarten visitors”, the actual value of the number of kindergarten visitors in each year aggregated in the local government with the local government name=“aaa” is recorded.

In the first embodiment, it is assumed that the actual value of the population from 1990 to 2004, the actual value of the number of births, the actual value of the number of in-migrants, the actual value of taxable income, the actual value of the number of kindergarten visitors are respectively recorded in the time series data 200 of the local government. That is, in the first embodiment, the present time will be described as 2004.

The item of information included in the time-series data 200 of the local government illustrated in FIG. 2 is an example, and other information items may be included.

(2) Details of Nationwide Time-Series Data

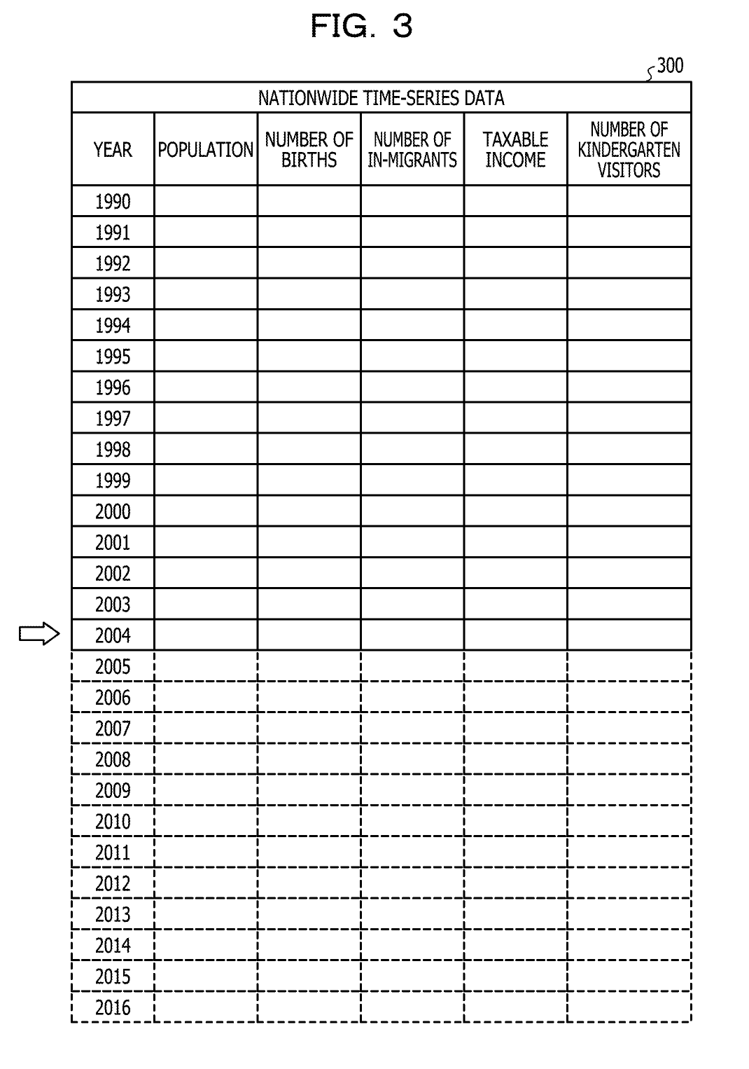

FIG. 3 is a diagram illustrating an example of nationwide time-series data among the time-series data stored in the time-series data storage device. As illustrated in FIG. 3, items of information included in the nationwide time-series data 300 are the same as items of information included in the time-series data 200 of the local government. Therefore, a detailed description of the nationwide time-series data 300 is omitted here.

Hardware Configuration of Each Device Included in Prediction System

Next, the hardware configuration of each device (terminal 110 to time-series data storage device 130) included in the prediction system 100 will be described. Since the hardware configuration of each device included in the prediction system 100 is substantially the same, here, the hardware configuration of the server device 120 will be described.

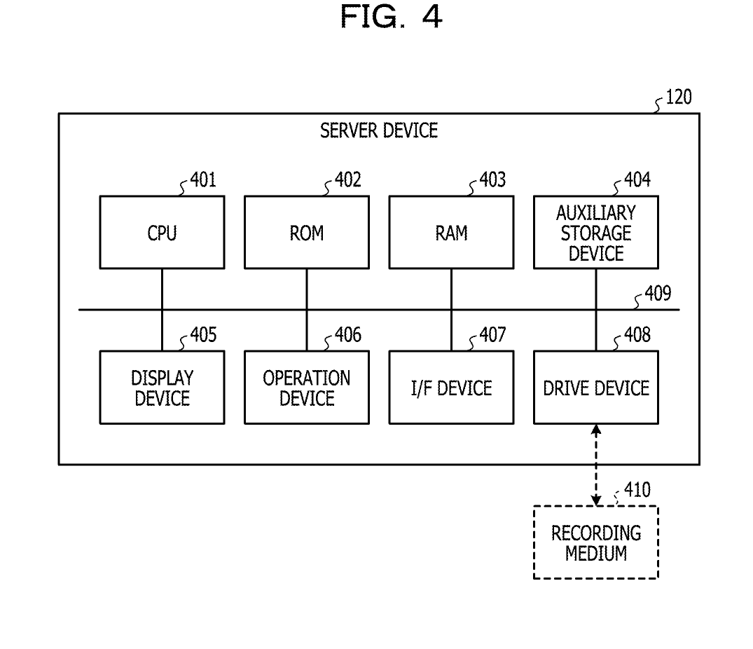

FIG. 4 is a diagram illustrating an example of a hardware configuration of a server device. As illustrated in FIG. 4, the server device 120 includes a central processing unit (CPU) 401, a read-only memory (ROM) 402, and a random-access memory (RAM) 403. The CPU 401, the ROM 402, and the RAM 403 form a so-called computer.

In addition, the server device 120 includes an auxiliary storage device 404, a display device 405, an operation device 406, an interface (I/F) device 407, and a drive device 408. The respective hardware of the server device 120 is mutually connected via a bus 409.

The CPU 401 is a device that executes various programs (for example, a prediction program and the like) installed in the auxiliary storage device 404.

The ROM 402 is a nonvolatile memory. The ROM 402 functions as the main storage device that stores various programs, data, and the like desired for the CPU 401 to execute various programs installed in the auxiliary storage device 404. More specifically, the ROM 402 functions as the main storage device that stores boot programs such as basic input and output system (BIOS) and an extensible firmware interface (EFI).

The RAM 403 is a volatile memory such as dynamic random-access memory (DRAM) or static random-access memory (SRAM). The RAM 403 functions as the main storage device that provides a work area to be developed when various programs installed in the auxiliary storage device 404 are executed by the CPU 401.

The auxiliary storage device 404 is an auxiliary storage device that stores various programs and information generated by executing various programs. For example, the analysis data storage unit 122 is realized in the auxiliary storage device 404.

The display device 405 is a display device that displays the internal state and the like of the server device 120. The operation device 406 is an input device for an administrator of the server device 120 to input various instructions to the server device 120.

The I/F device 407 is a communication device that is connected to the network 140 and communicates with the terminal 110 and the time-series data storage device 130.

The drive device 408 is a device for setting a recording medium 410. The recording medium 410 referred to here includes a medium that optically, electrically or magnetically records information, such as a CD-ROM, a flexible disk, a magneto-optical disk, and the like. In addition, the recording medium 410 may include a semiconductor memory or the like that electrically records information such as a ROM, a flash memory, or the like.

Various programs installed in the auxiliary storage device 404 are installed, for example, by setting the distributed recording medium 410 in the drive device 408 and reading various programs recorded in the recording medium 410 by the drive device 408. Alternatively, various programs to be installed in the auxiliary storage device 404 may be installed by being downloaded from the network 140 via the I/F device 407.

Functional Configuration of Server Device

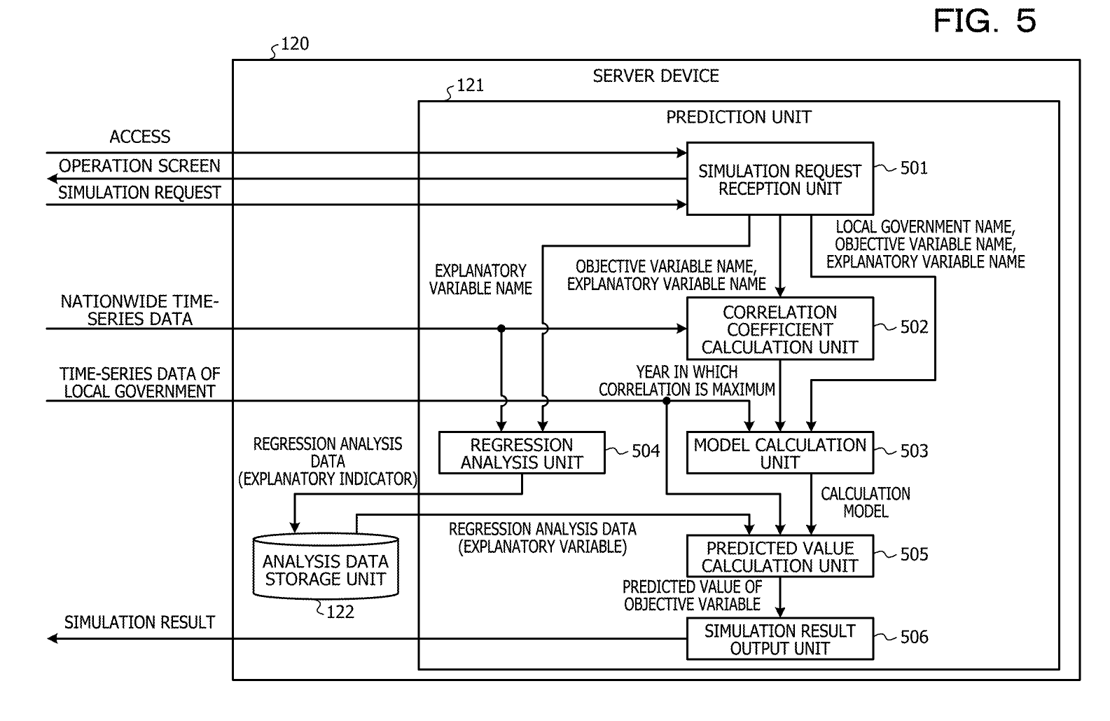

Next, the functional configuration of the server device 120 will be described. FIG. 5 is a diagram illustrating an example of a functional configuration of the server device.

As illustrated in FIG. 5, the prediction unit 121 of the server device 120 includes a simulation request reception unit 501, a correlation coefficient calculation unit 502, a model calculation unit 503, a regression analysis unit 504, a prediction value calculation unit 505, and a simulation result output unit 506.

In response to an access from the terminal 110, the simulation request reception unit 501 transmits an operation screen for making a simulation request to the terminal 110.

In addition, in response to transmitting the operation screen to the terminal 110, the simulation request reception unit 501 receives a simulation request transmitted from the terminal 110. In addition, the simulation request reception unit 501 identifies a local government name, an objective variable name, and an explanatory variable name included in the simulation request. In addition, the simulation request reception unit 501 notifies the correlation coefficient calculation unit 502 of the identified objective variable name and explanatory variable name. In addition, the simulation request reception unit 501 notifies the model calculation unit 503 of the identified local government name, the objective variable name, and the explanatory variable name. Furthermore, the simulation request reception unit 501 notifies the regression analysis unit 504 of the identified explanatory variable name.

The correlation coefficient calculation unit 502 is an example of a specifying unit. The correlation coefficient calculation unit 502 acquires the nationwide time-series data 300 corresponding to the objective variable name and the explanatory variable name notified from the simulation request reception unit 501 from the time-series data storage device 130.

In addition, the correlation coefficient calculation unit 502 calculates a correlation value between the actual value of the objective variable and the actual value of each explanatory variable by using the acquired nationwide time-series data 300. At this time, the correlation coefficient calculation unit 502 calculates the correlation value of each year while shifting the actual value of each explanatory variable used for calculating the correlation value by one year.

Furthermore, the correlation coefficient calculation unit 502 specifies the year (that is, years to be extracted from time series data) in which the correlation value is the maximum among the years in which the correlation value is calculated between the actual value of the objective variable and the actual value of each explanatory variable and notifies the model calculation unit 503.

The model calculation unit 503 is an example of a first calculation unit. The model calculation unit 503 calculates a calculation model by calculating a plurality of regression coefficients of a regression equation (calculation model) with the actual value of the explanatory variable of the notified year (period to be extracted) as input, based on the time-series data 200 of the local government. When calculating the regression coefficient, the model calculation unit 503 uses the time-series data 200 of the local government according to the objective variable name and the explanatory variable name notified from the simulation request reception unit 501. In addition, the model calculation unit 503 notifies the calculated calculation model to the predicted value calculation unit 505.

The regression analysis unit 504 acquires the nationwide time-series data 300 corresponding to the explanatory variable name notified from the simulation request reception unit 501 from the time-series data storage device 130. In addition, based on the acquired nationwide time-series data 300, the regression analysis unit 504 performs a regression analysis on the actual values of each explanatory variable to calculate regression analysis data. In addition, the regression analysis unit 504 stores the calculated regression analysis data in the analysis data storage unit 122.

The predicted value calculation unit 505 is an example of a second calculation unit. The predicted value calculation unit 505 calculates a predicted value of the objective variable based on the calculated model notified from the model calculation unit 503. The predicted value calculation unit 505 inputs the time-series data 200 of the local government corresponding to each explanatory variable name or the regression analysis data corresponding to each explanatory variable in the calculation model, thereby calculating a predicted value of the objective variable. The predicted value calculation unit 505 notifies the simulation result output unit 506 of the calculated predicted value of the objective variable.

The simulation result output unit 506 outputs the simulation result including the predicted value of the objective variable to the terminal 110.

Specific Example of Processing of Each Unit Included in Prediction Unit of Server Device

Next, a specific example of processing of each unit included in the prediction unit 121 of the server device 120 will be described.

(1) Specific Example of Processing by Simulation Request Reception Unit

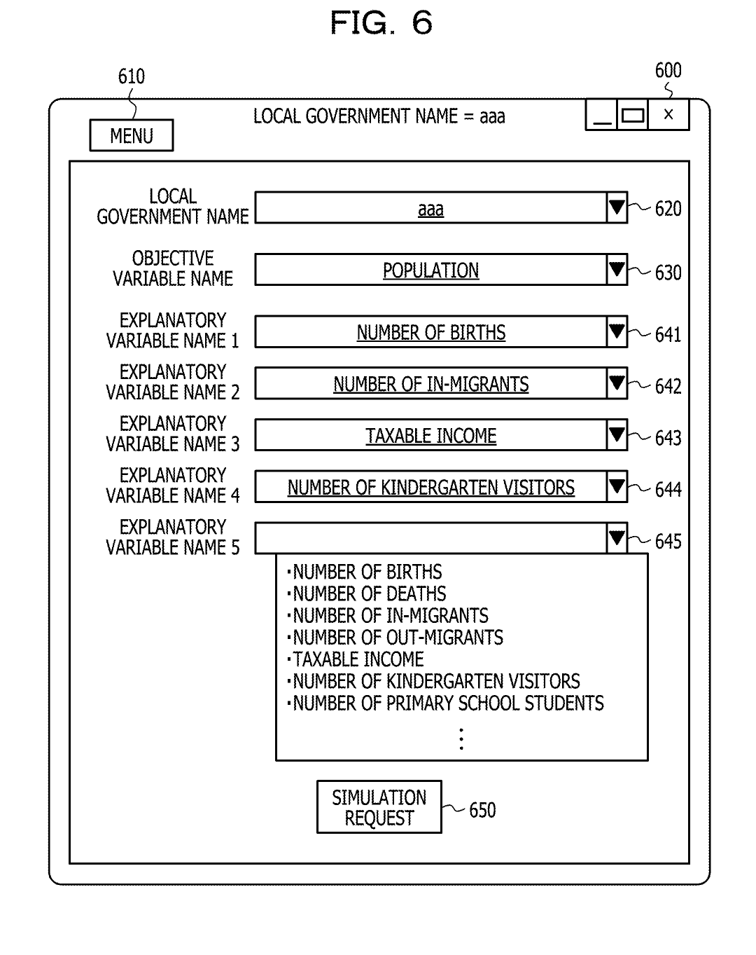

First, a specific example of the operation screen transmitted from the simulation request reception unit 501 and displayed on the terminal 110 will be described. FIG. 6 is a diagram illustrating a specific example of an operation screen transmitted by a simulation request reception unit. As illustrated in FIG. 6, an operation screen 600 includes a menu button 610. The menu button is a button for displaying a list of services provided by the server device 120 in a selectable way. Here, it is assumed that the prediction service is selected among the services provided by the server device 120.

When the prediction service is selected, the local government name (“aaa”) that owns the terminal 110 is displayed on the operation screen 600. Furthermore, a local government name input field 620, an objective variable name input field 630, an explanatory variable name 1 input field 641 to an explanatory variable name 5 input field 645 are displayed on the operation screen 600.

In the local government name input field 620, the name of the local government to be predicted is input. The name of the local government is input by being selected by the user from the list of local government names displayed by pressing a selection button (button indicated by a black triangle in the drawing). In the example of FIG. 6, “aaa” is selected as the local government name.

In the objective variable name input field 630, a variable name of the objective variable desired to be predicted by the user of the terminal 110 is input. The objective variable name to be predicted is input by being selected by the user from the list of objective variable names displayed by pressing a selection button. In the example of FIG. 6, “population” is selected as an objective variable name.

In the explanatory variable name 1 input field 641, a variable name of an explanatory variable having a strong relationship with the actual value of the objective variable desired to be predicted by the user of the terminal 110 is input. The explanatory variabley name 1 input field 641 may be directly keyed by the user or may be input by being selected by the user from the list of explanatory variable names displayed by pressing a selection button.

The explanatory variable name displayed by pressing the selection button may be an arbitrary explanatory variable name or an explanatory variable name whose correlation with the objective variable name input in the objective variable name input field 630 is equal to or more than a predetermined threshold value, among predefined explanatory variable names.

In the example of FIG. 6, the number of births is input in the explanatory variable name 1 input field 641, the number of in-migrants is input in the explanatory variable name 2 input field 642, taxable income is input in the explanatory variable name 3 input field 643, and the number of kindergarten visitors is input in the explanatory variable name 4 input field 644.

In addition, in the example of FIG. 6, a selection button is pressed and a list of explanatory variable names is displayed in the explanatory variable name 5 input field 645.

In addition, the operation screen 600 includes a simulation request button 650. As the simulation request button 650 is pressed, the terminal 110 transmits a simulation request to the server device 120. The transmitted simulation request includes a local government name input in the local government name input field 620, an objective variable name input in the objective variable name input field 630, and explanatory variable names input in the explanatory variable name 1 input field 641 to the explanatory variable name 4 input field 644.

In the case of the operation screen 600 illustrated in FIG. 6, the simulation request includes the local government name=aaa, the objective variable name=population, explanatory variable names 1 to 4=the number of births, the number of in-migrants, taxable income, and the number of kindergarten visitors.

In the example of FIG. 6, the case of transmitting four explanatory variable names is illustrated, but the number of explanatory variable names transmitted to the server device 120 is not limited to four and may be three or less, or five or more.

(2) Specific Example of Processing by Correlation Coefficient Calculation Unit

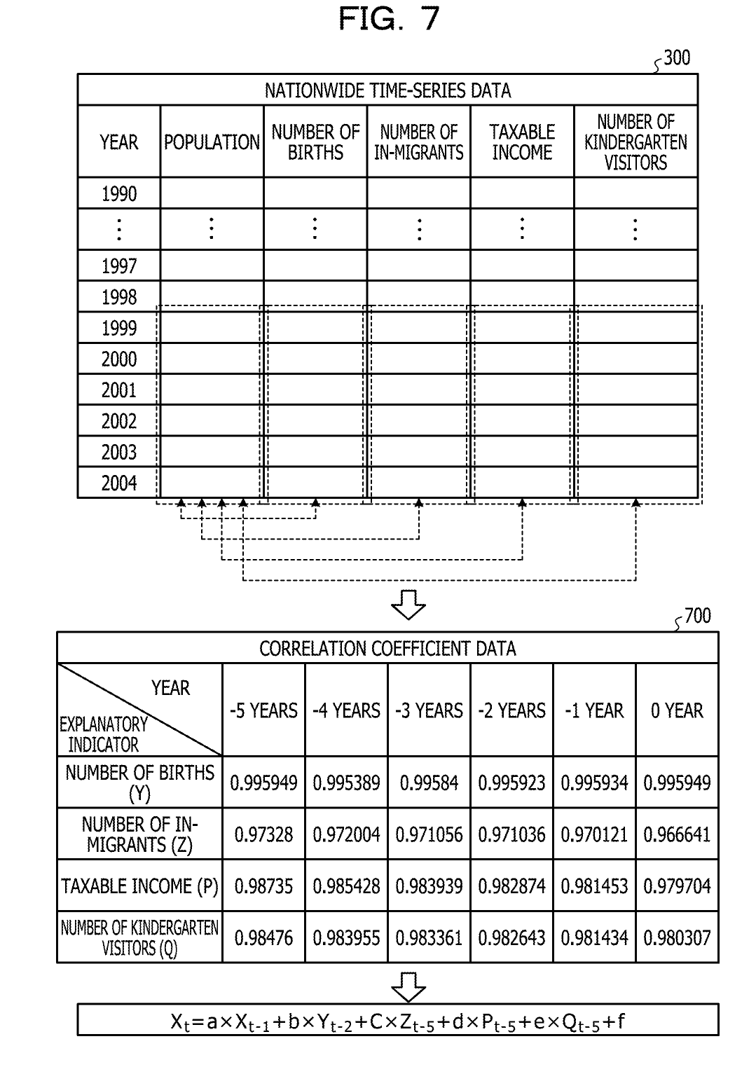

FIG. 7 is a diagram illustrating a specific example of processing by a correlation coefficient calculation unit. The correlation coefficient calculation unit 502 acquires nationwide time-series data 300 corresponding to the objective variable name (population), the explanatory variable name (number of births, number of in-migrants, taxable income), and the number of kindergarten visitors) received from the simulation request reception unit 501 from the time-series data storage device 130.

The nationwide time-series data 300 in FIG. 7 indicates the nationwide time-series data acquired by the correlation coefficient calculation unit 502. The example of FIG. 7 indicates the actual values of “population”, “number of births”, “number of in-migrants”, “taxable income”, “number of kindergarten visitors” in each year from 1990 to the present time (2004) are acquired.

The correlation coefficient calculation unit 502 calculates a correlation value r between the actual value of the objective variable in the past 5 years including the present time and the actual value of each explanatory variable in the past 5 years including the present time based on the acquired nationwide time-series data 300, for example, based on the following equations. Specifically, a correlation value between the actual value of the population from 1999 to 2004 and the actual value of the number of births from 1999 to 2004 is calculated based on the following equation. Similarly, a correlation value between the actual value of the population from 1999 to 2004 and the actual value of the number of in-migrants in each year from 1999 to 2004, a correlation value with the actual value of the taxable income, and a correlation value with the actual value of the number of kindergarten visitors are calculated based on the following equation.

$$r = \frac{{Σ}_{i = 1}^{n} ( {x}_{i} - {x}_{avg} ) ( {y}_{i} - {y}_{avg} )}{\sqrt{( {{Σ}_{i = 1}^{n} ( {x}_{i} - {x}_{avg} )}^{2} ) ( {{Σ}_{i = 1}^{n} ( {y}_{i} - {y}_{avg} )}^{2} )}} \qquad Equation 1$$

In the above equation, the actual value of each explanatory variable in each year from 1999 to 2004 is input to xᵢ. In addition, the actual value of the objective variable for each year from 1999 to 2004 is input to yᵢ.

Further, the average value of actual values of each explanatory variable (in the case of FIG. 7, the average value of actual values from 1999 to 2004) is input to x_{Avg}. In addition, the average value of actual values of the objective variable (in the case of FIG. 7, the average value of actual values from 1999 to 2004) is input to y_{Avg}. In the case of FIG. 7, n=5 is input.

Correlation value data 700 in FIG. 7 indicates the correlation value of each year calculated by the correlation coefficient calculation unit 502 based on the above equation while shifting the actual value of each explanatory variable used for calculating the correlation value by one year.

For example, “0 year” in the correlation value data 700 indicates a correlation value between the actual value of the objective variable in each year from 1999 to 2004 and the actual value of each explanatory variable in each year from 1999 to 2004.

In addition, “−1 year” indicates a correlation between the actual value of the objective variable in each year from 1999 to 2004 and the actual value of each explanatory variable in each year from 1998 to 2003. In addition, “−2 years” indicates a correlation between the actual value of the objective variable in each year from 1999 to 2004 and the actual value of each explanatory variable in each year from 1997 to 2002. In addition, “−3 years” indicates a correlation between the actual value of the objective variable in each year from 1999 to 2004 and the actual value of each explanatory variable in each year from 1996 to 2001. In addition, “−4 years” indicates a correlation between the actual value of the objective variable in each year from 1999 to 2004 and the actual value of each explanatory variable in each year from 1995 to 2000. Furthermore, “−5 year” indicates a correlation between the actual value of the objective variable in each year from 1999 to 2004 and the actual value of each explanatory variable in each year from 1994 to 1999.

For example, the correlation value between the actual value of the objective variable name=“population” at present time and the actual value of the explanatory variable name=“number of births” in each year is “0.99549” in “−5 years”. In contrast, “0.995389” in “−4 years” and “0.99584” in “−3 years” are gradually increasing. Then, the correlation value between the actual value of the population and the actual value of the number of births is “0.995923” as the maximum value in “−2 year” and gradually decreases to “0.995834” in “−1 year” and “0.995949” in “0 year”.

Therefore, in the case of the actual value with the explanatory variable name=“number of births”, the correlation value with the actual value of the objective variable name=“population” at the present time becomes the maximum when the actual value of the explanatory variable is the value in “−2 years”. That is, the year to be extracted is “−2 years”.

Similarly, when a correlation value is calculated for the actual value of each explanatory variable name=“number of in-migrants”, “taxable income”, and “number of kindergarten visitors” in each year, in the case of these explanatory variables, the correlation value with the actual value of the objective variable at the present time becomes the maximum in “−5 years”. That is, the year to be extracted is “−5 years”.

The correlation coefficient calculation unit 502 notifies the model calculation unit 503 of the year in which the correlation value is maximum for each explanatory variable. As a result, the model calculation unit 503 may generate a regression equation (calculation model) indicated in the following equation.

Xₜ=a×Xₜ₋₁+b×Yₜ₋₂+c×Zₜ₋₅+d×Pₜ₋₅+e×Qₜ₋₅+f Equation 2

Xₜ₋₁ indicates that the actual value of the population one year ago is input. In addition, Yₜ₋₂ indicates that the actual value of the number of births 2 years ago will be input. Furthermore, Zₜ₋₅, Pₜ₋₅, and Qₜ₋₅ indicate that the actual value of the number of in-migrants 5 years ago, the actual value of taxable income 5 years ago, and the actual number of kindergarten visitors 5 years ago are input, respectively. In addition, f represents a constant term.

(3) Specific Example of Processing by Model Calculation Unit

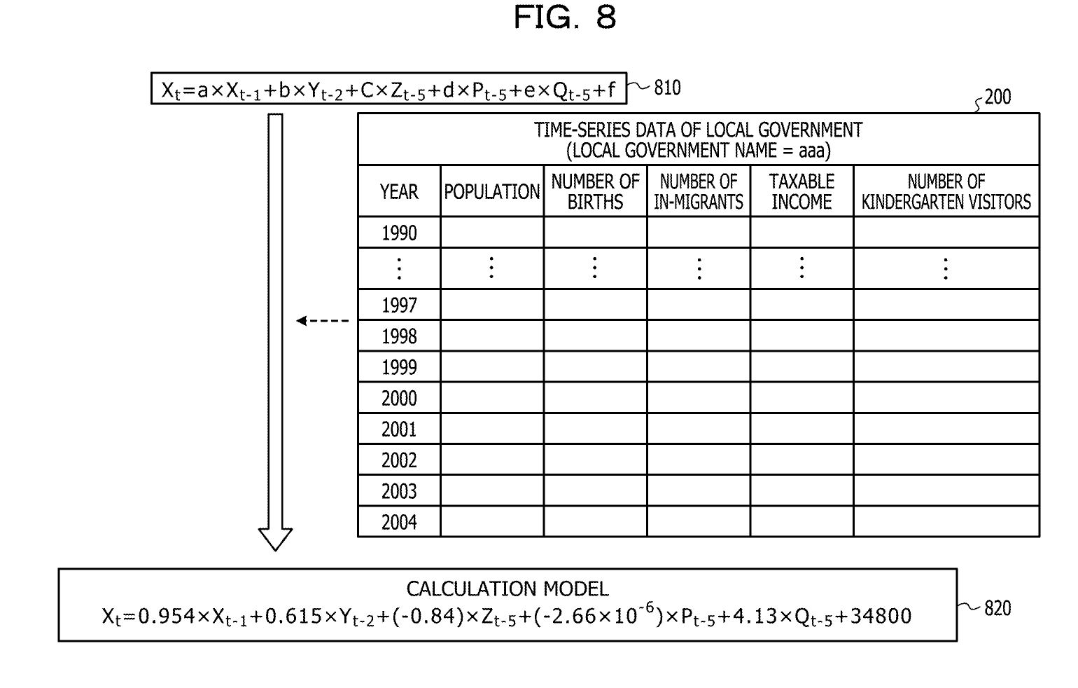

FIG. 8 is a diagram illustrating a specific example of processing by a model calculation unit. The model calculation unit 503 generates a calculation model based on the year in which the correlation value is the maximum, which is notified from the correlation coefficient calculation unit 502 and substitutes the time-series data of the local government to be predicted, thereby calculating a plurality of regression coefficients and constant terms included in the generated calculation model.

Specifically, the model calculation unit 503 first generates a calculation model 810 based on the year in which the correlation value is maximum. Subsequently, the model calculation unit 503 acquires the time-series data 200 of the local government according to the local government name, the objective variable name and the explanatory variable name notified from the simulation request reception unit 501 from the time-series data storage device 130 and substitute the data into the calculation model 810. As a result, the model calculation unit 503 calculates a plurality of regression coefficients (a, b, c, d, and e) and a constant term (f).

In the example of FIGS. 8, a=0.954, b=0.615, c=−0.84, d=−2.66×10⁻⁶, and e=4.13 are calculated as a plurality of regression coefficients, (f)=34800 is calculated as a constant term, and a calculation model 820 is calculated (see the following equation).

Xₜ=0.954×Xₜ₋₁+0.615×Yₜ₋₂+(−0.84)×Zₜ₋₅+(−2.66×10⁻⁶)×Pₜ₋₅+4.13×Qₜ₋₅+34800 Equation 3

The model calculation unit 503 notifies the prediction value calculation unit 505 of the calculation model 820 including the plurality of calculated regression coefficients and the constant terms.

(4) Specific Example of Processing by Regression Analysis Unit

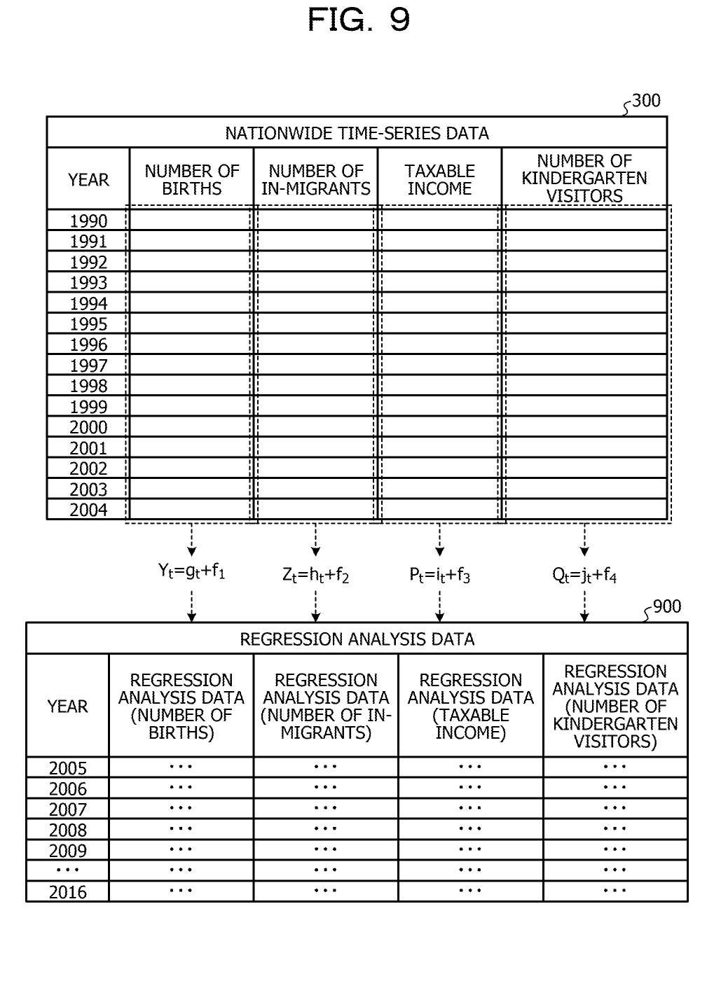

FIG. 9 is a diagram illustrating a specific example of processing by a regression analysis unit. The regression analysis unit 504 acquires nationwide time-series data 300 corresponding to the explanatory variable name notified from the simulation request reception unit 501 from the time-series data storage device 130 to perform a regression analysis on actual values of each explanatory variable.

The nationwide time-series data 300 of FIG. 9 indicates the nationwide time-series data 300 acquired by the regression analysis section 504. The regression analysis unit 504 performs a regression analysis on the actual value of the number of births from 1990 to 2004 with the explanatory variable name=“number of births” included in the nationwide time-series data 300, thereby calculating a regression equation Yₜ=gₜ+f₁.

Similarly, the regression analysis unit 504 performs a regression analysis on the actual value of the number of in-migrants from 1990 to 2004 with the explanatory variable name=“number of in-migrants” included in the nationwide time-series data 300, thereby calculating a regression equation Zₜ=hₜ+f₂.

In addition, the regression analysis unit 504 performs a regression analysis on the actual value of the taxable income from 1990 to 2004 with the explanatory variable name=“taxable income” included in the nationwide time-series data 300, thereby calculating a regression equation Pₜ=iₜ+f₃.

Furthermore, the regression analysis unit 504 performs a regression analysis on the actual value of the number of kindergarten visitors with the explanatory variable name=“number of kindergarten visitors” from 1990 to 2004 included in the nationwide time-series data 300, thereby calculating a regression equation Qₜ=jₜ+f₄.

In this manner, by calculating the regression equation for the actual value of each explanatory variable, the regression analysis unit 504 may calculate an estimated value of each explanatory variable ahead of the present time (2004). Regression analysis data 900 indicates the result of calculating an estimated value of each explanatory variable ahead of the present time point (2004).

Specifically, the regression analysis data 900 indicates the result of the regression analysis unit 504 calculating an estimated value of the number of births from 2005 to 2016 by using a regression equation Yₜ=gₜ+f₁. In addition, the regression analysis data 900 indicates the result of the regression analysis unit 504 calculating an estimated value of the number of in-migrants from 2005 to 2016 by using a regression equation Zₜ=hₜ+f₂.

In addition, the regression analysis data 900 indicates the result of the regression analysis unit 504 calculating estimated values of taxable income from 2005 to 2016 by using a regression equation Pₜ=iₜ+f₃. In addition, the regression analysis data 900 indicates the result of the regression analysis unit 504 calculating an estimated value of the number of kindergarten visitors from 2005 to 2016 by using a regression equation Qₜ=jₜ+f₄.

The regression analysis unit 504 stores the calculated regression analysis data 900 in the analysis data storage unit 122.

(5) Specific Example of Processing by Predicted Value Calculation Unit

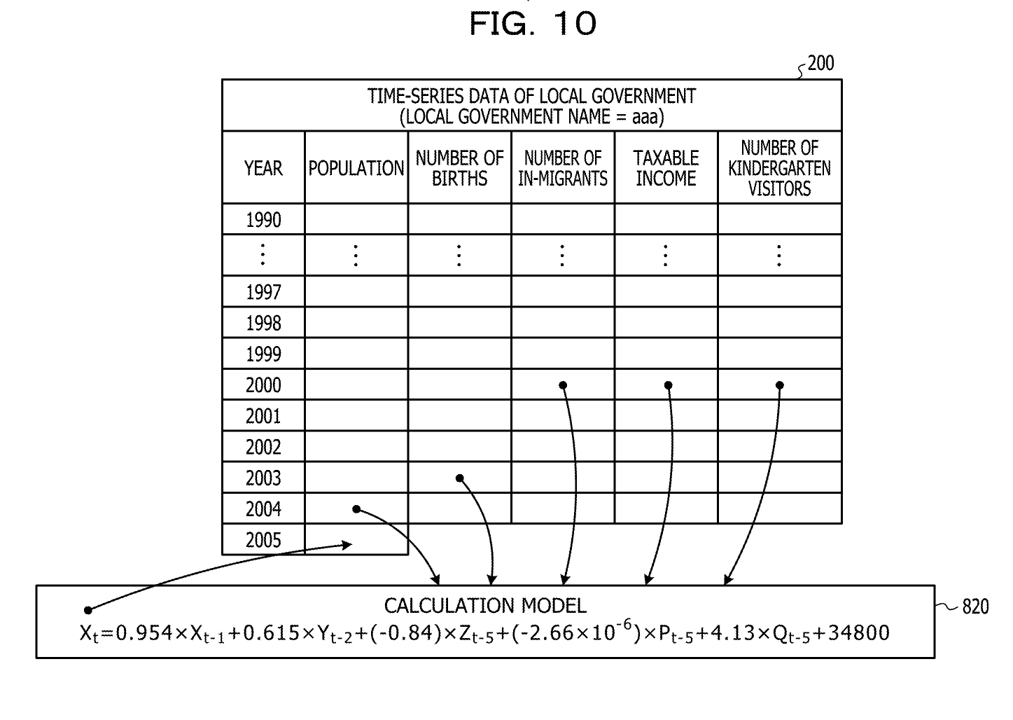

FIG. 10 is a first diagram illustrating a specific example of processing by the predicted value calculation unit. The predicted value calculation unit 505 calculates the predicted value of the objective variable by using the time-series data 200 of the local government acquired from the time-series data storage device 130 or the regression analysis data 900 acquired from the analysis data storage unit 122.

The example in FIG. 10 indicates how to calculate the predicted value of the objective variable (population) in one year (2005) after the present time (2004). The predicted value calculation unit 505 substitutes the time-series data 200 of the local government acquired from the time-series data storage device 130 into each term of the calculation model 820 notified from the model calculation unit 503, thereby calculating the predicted value of the objective variable (population) in 2005.

Specifically, from the time-series data 200 of the local government, the predicted value calculation unit 505 acquires an actual value of the population in 2004, an actual value of the number of births in 2003, an actual value of the number of in-migrants in 2000, an actual value of taxable income in 2000, and an actual value of the number of kindergarten visitors in 2000. Then, the predicted value calculation unit 505 calculates the predicted value of the population in 2005 by substituting the acquired actual value into the calculation model 820.

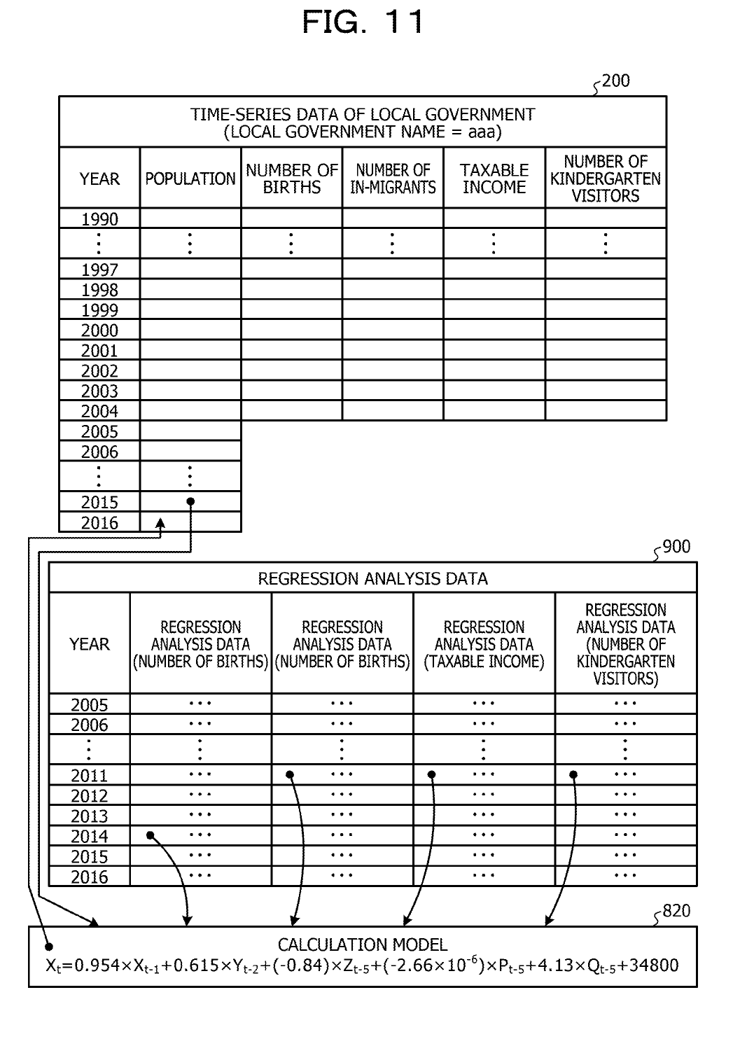

FIG. 11 is a second diagram illustrating a specific example of processing by the predicted value calculation unit. The example in FIG. 11 indicates how to calculate the predicted value of the objective variable (population) in 12 years (2016) after the present time (2004). The predicted value calculation unit 505 substitutes the regression analysis data 900 and the like read from the analysis data storage unit 122 into each term of the calculation model 820 notified from the model calculation unit 503, thereby calculating the objective variable (population) of 2016.

Specifically, the predicted value calculation unit 505 acquires the calculated predicted value of the population of 2015. In addition, based on the regression analysis data 900, the predicted value calculation unit 505 acquires an estimated value of the number of births in 2014, an estimated value of the number of in-migrants in 2011, an estimated value of taxable income in 2011, and the number of kindergarten visitors in 2011. Then, the predicted value calculation unit 505 calculates the predicted value of the population in 2016 by substituting the acquired predicted value and estimated value into the calculation model 820.

The predicted value calculation unit 505 sequentially calculates the predicted value of the objective variable for each year ahead of the present time (2004) and notifies the simulation result output unit 506.

(6) Specific Example of Processing by Simulation Result Output Unit

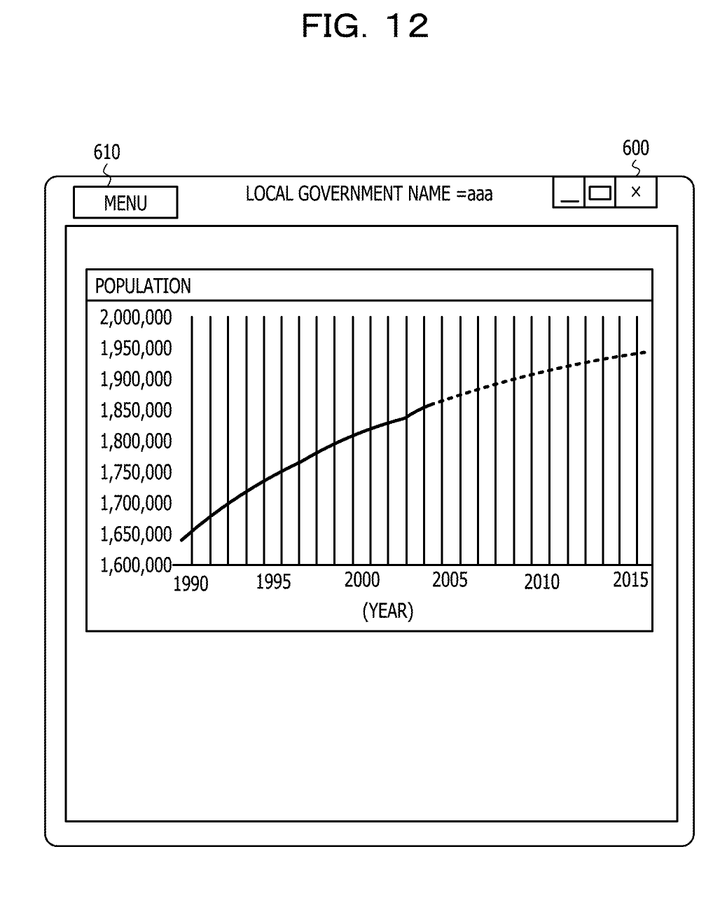

FIG. 12 is a diagram illustrating a specific example of processing by a simulation result output unit. When receiving the predicted value of the objective variable for each year ahead of the present time (2004) from the predicted value calculation unit 505, the simulation result output unit 506 outputs the actual value of the objective variable up to the present time (2004) and generates a graph 1200. In addition, the simulation result output unit 506 transmits the generated graph 1200 to the terminal 110 as a simulation result. As a result, the graph 1200 is displayed on the operation screen 600 of the terminal 110.

In the example of the graph 1200 in FIG. 12, the actual value of the objective variable (population) from 1990 to 2004 is indicated by a solid line and the predicted value of the objective variable (population) from 2005 to 2016 is indicated by a dotted line. In the graph 1200 of FIG. 12, the horizontal axis represents “year” and the vertical axis represents “population”.

As illustrated in FIG. 12, it is possible for the user of the terminal 110 to easily grasp the transition of the actual value of the objective variable up to the present time and the transition of the predicted value of the objective variable ahead of the present time by displaying the actual value of the objective variable (population) together with the predicted value of the objective variable (population).

Flow of Prediction Processing

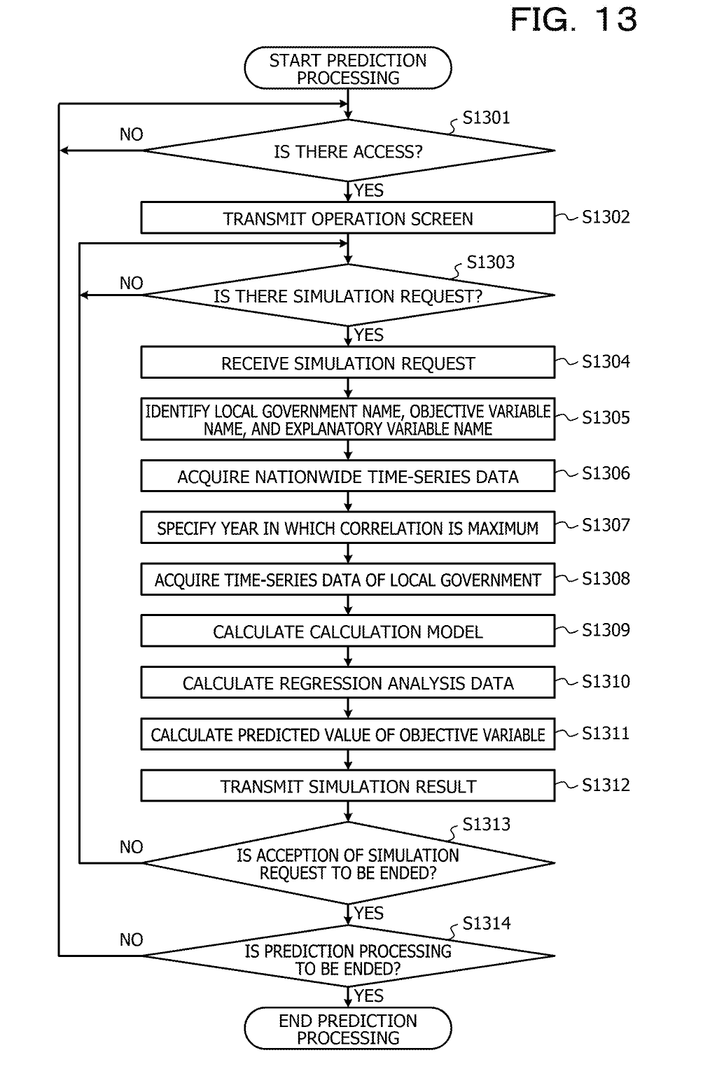

Next, a flow of prediction processing by the prediction unit 121 of the server device 120 will be described. FIG. 13 is a flowchart illustrating a flow of prediction processing. When the prediction unit 121 is activated in the server device 120, the prediction processing illustrated in FIG. 13 is started, and the provision of the prediction service is started.

In step S1301, the simulation request reception unit 501 determines whether or not there is an access to the prediction service from the terminal 110. If it is determined that there is no access (in the case of No in step S1301), the simulation request reception unit 501 waits until there is an access.

On the other hand, if it is determined in step S1301 that there is an access (in the case of Yes in step S1301), the process proceeds to step S1302. In step S1302, the simulation request reception unit 501 transmits the operation screen 600 of FIG. 6 to the terminal 110 that has accessed.

In step S1303, the simulation request reception unit 501 determines whether or not there is a simulation request from the terminal 110 that has transmitted the operation screen 600. In step S1303, if it is determined that there is no simulation request (in the case of No in step S1303), the simulation request reception unit 501 waits until there is a simulation request.

On the other hand, if it is determined in step S1303 that there is a simulation request (in the case of Yes in step S1303), the process proceeds to step S1304.

In step S1304, the simulation request reception unit 501 receives a simulation request. In step S1305, the simulation request reception unit 501 identifies a local government name, an objective variable name, and an explanatory variable name included in the simulation request.

In step S1306, the correlation coefficient calculation unit 502 acquires the nationwide time-series data 300 corresponding to the objective variable name and the explanatory variable name identified by the simulation request reception unit 501 from the time-series data storage device 130.

In step S1307, the correlation coefficient calculation unit 502 calculates a correlation value between the actual value of the objective variable at the present time and the actual value of each explanatory variable in each year and specifies the year in which the correlation value is the maximum for each explanatory variable based on the acquired nationwide time-series data 300.

In step S1308, the model calculation unit 503 generates the calculation model 810 based on the year in which the correlation is maximum, which is specified for each explanatory variable. In addition, the model calculation unit 503 acquires the time-series data 200 of the local government according to the local government name, the objective variable name, and the explanatory variable name identified by the simulation request reception unit 501 from the time-series data storage device 130.

In step S1309, the model calculation unit 503 calculates a plurality of regression coefficients and constant terms by inputting the acquired time-series data 200 of the local government into the calculation model 810 to calculate the calculation model 820.

In step S1310, the regression analysis unit 504 acquires nationwide time-series data 300 corresponding to the explanatory variable name identified by the simulation request reception unit 501 from the time-series data storage device 130. In addition, the regression analysis unit 504 calculates the regression analysis data 900 by performing a regression analysis on the obtained nationwide time-series data 300 for each explanatory variable. In addition, the regression analysis unit 504 stores the calculated regression analysis data 900 in the analysis data storage unit 122.

In step S1311, the predicted value calculation unit 505 calculates a predicted value of the objective variable by inputting the time-series data 200 or the regression analysis data 900 of the local government to the calculation model 820 calculated by the model calculation unit 503.

In step S1312, the simulation result output unit 506 draws a graph of the predicted value of the objective variable calculated by the predicted value calculation unit 505 together with the actual value and transmits the graph to the terminal 110 as a simulation result.

In step S1313, the simulation request reception unit 501 determines whether or not to end the acceptance of the simulation request from the terminal 110. If it is determined in step S1313 that acceptance of the simulation request from the terminal 110 is not ended (in the case of No in step S1313), the process returns to step S1303.

On the other hand, if it is determined in step S1313 that the acceptance of the simulation request from the terminal 110 is to be ended, the process proceeds to step S1314. In step S1314, the simulation request reception unit 501 determines whether or not to end the prediction processing.

If it is determined in step S1314 that the prediction processing is not ended (in the case of No in step S1314), the process proceeds to step S1301. In this case, the provision of the prediction service is continued. On the other hand, in step S1314, if it is determined that the prediction processing to be ended (in the case of Yes in step S1314), the prediction processing is ended and the provision of the prediction service is stopped.

Verification of Simulation Result

Next, the prediction accuracy of future prediction by simulation will be verified. In the above description, the present time=2004, but in reality, actual values from 2005 to 2016 already exist as time-series data of a local government and nationwide time-series data. Therefore, by comparing the predicted values of the objective variable (population) from 2005 to 2016 with the actual values of the objective variable (population) from 2005 to 2016 in the case of the present time=2004, the prediction accuracy of future prediction by simulation is verified.

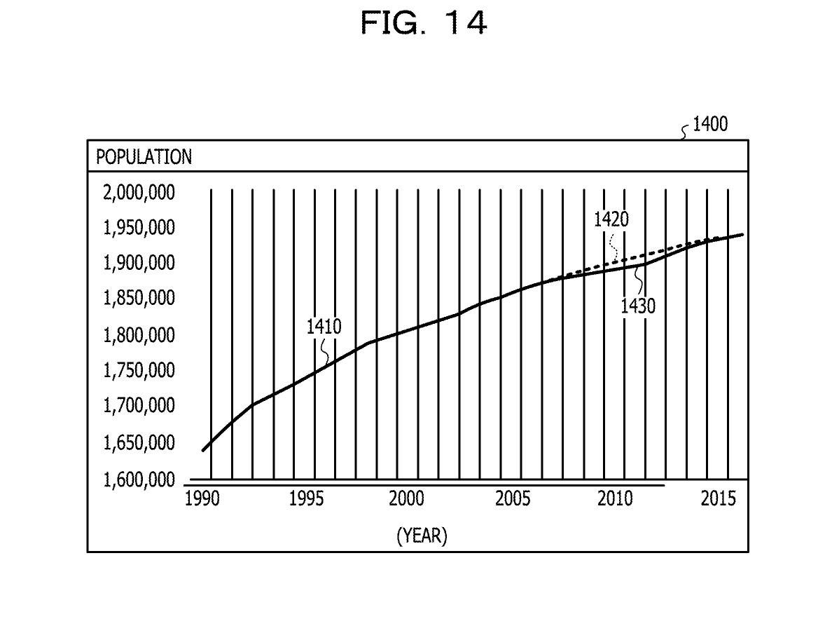

FIG. 14 is a diagram for verifying a simulation result. In the graph 1400, the horizontal axis represents “year” and the vertical axis represents “population”. The solid line 1410 from 1990 to 2004 indicates the trend of the actual value of the population of the local government=“aaa”.

On the other hand, the dotted line 1420 from 2005 to 2016 indicates the predicted value of the population calculated by the prediction unit 121. In addition, the solid line 1430 from 2005 to 2016 indicates the trend of the actual value of the population of the local government=“aaa”.

When comparing the dotted line 1420 and the solid line 1430 and calculating the prediction accuracy by using the following equation, the prediction accuracy=0.11% in the example of FIG. 14.

PREDICTION ACCURACY=Σ((PREDICTED VALUE)/ACTUAL VALUE) Equation 4

In this way, according to the prediction unit 121, it is possible to realize high prediction accuracy.

As apparent from the above description, the server device 120 according to the first embodiment calculates a correlation value between actual values of a plurality of explanatory variables and an actual value of an objective variable by using nationwide time-series data. In addition, the server device 120 in the first embodiment specifies a year in which the correlation value is the maximum as the year to be extracted for each of the plurality of explanatory variables.

In addition, the server device 120 according to the first embodiment extracts each actual value of a plurality of explanatory variables in the year in which the correlation value is the maximum from the time-series data of the local government to be predicted and calculates a plurality of regression coefficients of the regression equation for the actual value of the objective variable.

Furthermore, the server device 120 according to the first embodiment calculates a predicted value of the objective variable for the local government to be predicted by using the regression equation having the calculated plurality of regression coefficients.

As described above, it is possible to calculate a highly accurate predicted value by calculating a correlation value between the actual value of each explanatory variable and the actual value of the objective variable in advance and calculating a predicted value of the objective variable by using each explanatory variable in the year in which the correlation value is the maximum.

As a result, according to the server device 120 of the first embodiment, it is possible to improve the prediction accuracy of future prediction by simulation.

### Second Embodiment

In the first embodiment, the correlation coefficient calculation unit 502 specifies a year in which the correlation value with the actual value of the objective variable is the maximum for each explanatory variable by using the nationwide time-series data 300. However, the specifying method for specifying a year in which the correlation value with the actual value of the objective variable is the maximum is not limited thereto.

For example, instead of using the nationwide time-series data 300, the time-series data of the local government according to the scale of the local government to be predicted may be aggregated and used. For example, the scale of local governments may be divided into the following five. ⋅City designated by government ordinance (population: 500,000 or more) ⋅Large-scale city (population: 200,000 or more) ⋅Medium-scale city (population: 100,000 or more) ⋅Small-scale city (population: 50,000 or more)) ⋅Town (population: less than 50,000) When receiving the local government name from the simulation request reception unit 501, the correlation coefficient calculation unit 502 determines the scale of the local government to extract and aggregate time-series data of the local government according to the determined scale from the nationwide time-series data.

For example, it is assumed that the local government name received from the simulation request reception unit 501 is a city designated by government ordinance. In this case, the correlation coefficient calculation unit 502 extracts and aggregates the actual values of the population, the actual values of the number of births, the actual values of the number of in-migrants, the actual values of the taxable income, and the actual values of the number of kindergarten visitors of the city designated by government ordinance from 1990 to 2004 from the nationwide time-series data.

As described above, the correlation coefficient calculation unit 502 may calculate the correlation value according to the scale of the local government by calculating a correlation value by using the time-series data according to the scale of the local government.

### Third Embodiment

In the first embodiment, the regression analysis unit 504 performs a regression analysis on the actual value of each explanatory variable by using the nationwide time-series data 300 to calculate regression analysis data. However, the method of calculating the regression analysis data is not limited thereto.

For example, instead of using the nationwide time-series data 300, time-series data of the local government according to the scale of the local government to be predicted may be used. As with the second embodiment, the scale of the local government may be divided into the following five, for example. ⋅City designated by government ordinance (population: 500,000 or more) ⋅Large-scale city (population: 200,000 or more) ⋅Medium-scale city (population: 100,000 or more) ⋅Small-scale city (population: 50,000 or more)) ⋅Town (population: less than 50,000) When receiving the local government name from the simulation request reception unit 501, the regression analysis unit 504 determines the scale of the local government to extract and aggregate time-series data of the local government according to the determined scale from the nationwide time-series data.

For example, it is assumed that the local government name received from the simulation request reception unit 501 is a large-scale city. In this case, the regression analysis unit 504 extracts and aggregates the actual values of the number of births, the actual values of the number of in-migrants, the actual values of the taxable income, and the actual values of the number of kindergarten visitors of the large-scale city from 1990 to 2004 from the nationwide time-series data.

As described above, the regression analysis unit 504 may calculate regression analysis data according to the scale of the local government by performing a regression analysis by using time-series data according to the scale of the local government.

### Other Embodiments

In the first to third embodiments described above, it is assumed that the prediction system 100 includes one terminal 110, but the number of terminals included in the prediction system 100 is not limited to one, and a plurality of terminals may be provided. In this case, a plurality of terminals may be used by a plurality of users belonging to the same local government or by a plurality of users belonging to different local governments. That is, the server device 120 may be installed separately for each local government to provide prediction services to a plurality of users of each local government or may deploy prediction services on the cloud to provide the services to each user of a plurality of local governments.

In addition, in the first to third embodiments described above, it is assumed that the time-series data storage device 130 stores time-series data of a local government and nationwide time-series data, but these time-series data may be stored in different devices. In addition, the time-series data stored in the time-series data storage device 130 may be stored in the server device 120.

In addition, in the first to third embodiments, the regression analysis data 900 is calculated by the server device 120 and stored in the analysis data storage unit 122. However, the regression analysis data 900 may be acquired by the server device 120 and stored in the analysis data storage unit 122, which is calculated by another device.

In addition, in the first to third embodiments described above, it is assumed that the time-series data stored in the time-series data storage device 130 is aggregated on a yearly basis, but the time-series data may be aggregated every predetermined period other than a yearly basis.

In addition, in the first to third embodiments described above, it is assumed that the regression analysis data (estimated value of each explanatory variable) calculated by the regression analysis unit 504 is input to the calculation model 820. However, each explanatory variable to be input to the calculation model 820 is not limited to the estimated value, and an expected value may be input. In this way, it is possible to quantitatively verify the effect of measures introduced.

In addition, in the first to third embodiments described above, no mention was made of a charging method for providing a prediction service, but for example, the city in which the terminal 110 is installed, may be charged depending on the number of times or the time the terminal 110 has accessed the server device 120. Alternatively, according to the number of times that the terminal 110 has made a simulation request, the terminal 110 may be charged to the local government in which the terminal 110 is installed. Alternatively, a fixed amount may be charged to the local government in which the terminal 110 is installed on a monthly basis or on a yearly basis so as to provide a prediction service.

The present disclosure is not limited to the configurations described in the above embodiments, such as combinations with other elements and the like. With respect to these points, the present disclosure may be modified within a scope not deviating from the gist of the present disclosure and appropriately determined according to the application form thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A prediction apparatus comprising:
one or more memories; and
one or more processors coupled to the one or more memories and the one or more processors configured to
select each of specific periods for each of a plurality of explanatory variables on the basis of a correlation between actual values of each of the plurality of explanatory variables aggregated for each period and actual values of an objective variable aggregated for each period, the plurality of explanatory variables relating to the objective variable,
determine a plurality of regression coefficients of a regression equation relating to the objective variable on the basis of each specific actual value of the plurality of explanatory variables in each of the selected specific periods,
perform calculation of a predicted value of the objective variable by using the regression equation having the determined plurality of regression coefficients, and
output the calculated predicted value.

2. The prediction apparatus according to claim 1, wherein the calculation of the predicted value includes calculating the predicted value of the objective variable by inputting estimated values of the plurality of explanatory variables in each of the selected specified periods of the plurality of explanatory variables, which are estimated values calculated by performing a regression analysis for each of the actual values of the plurality of explanatory variables aggregated for each period, into the regression equation having the determined plurality of regression coefficients.

3. The prediction apparatus according to claim 1, wherein each of the selected specific period of the plurality of explanatory variables is specified by a difference from a certain period corresponding to an actual value of the objective variable used for determining the plurality of regression coefficients.

4. The prediction apparatus according to claim 1,
wherein the one or more processors are further configured to receive designation of region information,
wherein the actual values of the plurality of explanatory variables and the actual values of the objective variable are actual values of the plurality of explanatory variables and the objective variable regarding a second region whose a scale is related to a first region indicated by the received region information.

5. The prediction apparatus according to claim 2,
wherein the one or more processors are further configured to receive designation of region information,
wherein the estimated values are estimated values of the plurality of explanatory variables in each of the selected specified periods of the plurality of explanatory variables regarding a second region whose a scale is related to a first region indicated by the received region information.

6. A computer-implemented prediction method comprising:
selecting each of specific periods for each of a plurality of explanatory variables on the basis of a correlation between actual values of each of the plurality of explanatory variables aggregated for each period and actual values of an objective variable aggregated for each period, the plurality of explanatory variables relating to the objective variable;
determining a plurality of regression coefficients of a regression equation relating to the objective variable on the basis of each specific actual value of the plurality of explanatory variables in each of the selected specific periods;
calculating a predicted value of the objective variable by using the regression equation having the determined plurality of regression coefficients; and
outputting the calculated predicted value.

7. The prediction method according to claim 6, wherein the calculating includes calculating the predicted value of the objective variable by inputting estimated values of the plurality of explanatory variables in each of the selected specified periods of the plurality of explanatory variables, which are estimated values calculated by performing a regression analysis for each of the actual values of the plurality of explanatory variables aggregated for each period, into the regression equation having the determined plurality of regression coefficients.

8. The prediction method according to claim 6, wherein each of the selected specific period of the plurality of explanatory variables is specified by a difference from a certain period corresponding to an actual value of the objective variable used for determining the plurality of regression coefficients.

9. The prediction method according to claim 6, further comprising: receiving designation of region information,
wherein the actual values of the plurality of explanatory variables and the actual values of the objective variable are actual values of the plurality of explanatory variables and the objective variable regarding a second region whose a scale is related to a first region indicated by the received region information.

10. The prediction method according to claim 7, further comprising: receiving designation of region information,
wherein the estimated values are estimated values of the plurality of explanatory variables in each of the selected specified periods of the plurality of explanatory variables regarding a second region whose a scale is related to a first region indicated by the received region information.

11. A non-transitory computer-readable medium storing prediction program instructions executable by a least one computer, the prediction program instructions comprising:
instructions for selecting each of specific periods for each of a plurality of explanatory variables on the basis of a correlation between actual values of each of the plurality of explanatory variables aggregated for each period and actual values of an objective variable aggregated for each period, the plurality of explanatory variables relating to the objective variable;
instructions for determining a plurality of regression coefficients of a regression equation relating to the objective variable on the basis of each specific actual value of the plurality of explanatory variables in each of the selected specific periods;
instructions for calculating a predicted value of the objective variable by using the regression equation having the determined plurality of regression coefficients; and
instructions for outputting the calculated predicted value.

12. The medium according to claim 11, wherein the calculating includes calculating the predicted value of the objective variable by inputting estimated values of the plurality of explanatory variables in each of the selected specified periods of the plurality of explanatory variables, which are estimated values calculated by performing a regression analysis for each of the actual values of the plurality of explanatory variables aggregated for each period, into the regression equation having the determined plurality of regression coefficients.

13. The medium according to claim 11, wherein each of the selected specific period of the plurality of explanatory variables is specified by a difference from a certain period corresponding to an actual value of the objective variable used for determining the plurality of regression coefficients.

14. The medium according to claim 11, the prediction program instructions further comprising: instructions for receiving designation of region information,
wherein the actual values of the plurality of explanatory variables and the actual values of the objective variable are actual values of the plurality of explanatory variables and the objective variable regarding a second region whose a scale is related to a first region indicated by the received region information.

15. The medium according to claim 12, the prediction program instructions further comprising: instructions for receiving designation of region information,
wherein the estimated values are estimated values of the plurality of explanatory variables in each of the selected specified periods of the plurality of explanatory variables regarding a second region whose a scale is related to a first region indicated by the received region information.
